(19) United States
(12) Patent Application Publication
(10) Pub. No.: US 2010/0057282 A1
(43) Pub. Date: Mar. 4, 2010

(54) METHODS AND SYSTEMS FOR PROVIDING COMMUNICATIONS BETWEEN A BATTERY CHARGER AND A BATTERY CONTROL UNIT FOR A HYBRID VEHICLE

(75) Inventors: KERFEGAR K. KATRAK, Fenton, MI (US); JEFFREY T. WOLAK, Brighton, MI (US); GERY J. KISSEL, Northville, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/203,787

(22) Filed: Sep. 3, 2008

(51) Int. Cl. B60W 20/00

(52) U.S. Cl. 701/22

(57) ABSTRACT

A method for communicating between a battery charger and a battery control unit in a hybrid vehicle includes the steps of forming a first message with at least a renewable energy storage system (RESS) command and a command security measure for the RESS command, transmitting the first message from the battery control unit to the battery charger, forming a second message in response to the first message with at least an RESS response and a response security measure for the RESS response, and transmitting the second message from the battery charger to the battery control unit.

### FIELD OF THE INVENTION

The present invention generally relates to hybrid vehicles, and more particularly relates to methods and systems for communications between battery chargers and battery control units for hybrid vehicles.

### BACKGROUND OF THE INVENTION

Today's hybrid vehicles utilize a renewable energy storage system (RESS) in order to improve fuel efficiency. Specifically, today's hybrid vehicles are typically powered at least in part by an RESS battery, such as a relatively high voltage, lithium-ion battery. The RESS battery is typically charged by a battery charger based on instructions provided by a battery control unit. When the hybrid vehicle is in operation, the RESS battery may be charged at least in part using kinetic energy generated via a regenerative braking feature of the hybrid vehicle. When the hybrid vehicle is not in operation, the RESS battery is charged by the battery charger, typically connected to an electrical source, and using instructions provided by the battery control unit. The battery control unit typically provides instructions pertaining to the RESS battery as well as to one or more additional batteries in the hybrid vehicle, such as a relatively low voltage battery for a radio, instrument panel, navigation system, and/or other components of the hybrid vehicle.

Communications between the battery control unit and the battery charger assist in maintaining proper functioning of the relatively higher voltage RESS battery and the relatively lower voltage battery of the hybrid vehicle functioning properly. However, the information flow and level of security for communications between the battery control unit and the battery charger may not always be ideal.

Accordingly, it is desirable to provide an improved method for communicating between a battery control unit and a battery charger for a hybrid vehicle, for example with an improved information flow and/or improved security for values being transmitted therebetween. It is also desirable to provide a program product for improved communications between a battery control unit and a battery charger for a hybrid vehicle, for example with an improved information flow and/or improved security for values being transmitted therebetween. It is further desirable to provide a system for improved communications between a battery control unit and a battery charger for a hybrid vehicle, for example with an improved information flow and/or improved security for values being transmitted therebetween. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In accordance with an exemplary embodiment of the present invention, a method for communicating between a battery charger and a battery control unit in a hybrid vehicle is provided. The method comprises the steps of forming a first message with at least a renewable energy storage system (RESS) command and a command security measure for the RESS command, transmitting the first message from the battery control unit to the battery charger, forming a second message in response to the first message with at least an RESS response and a response security measure for the RESS response, and transmitting the second message from the battery charger to the battery control unit.

In accordance with another exemplary embodiment of the present invention, a program product for at least facilitating communications between a battery charger and a battery control unit in a hybrid vehicle is provided. The program product comprises a program and a computer-readable signal bearing media. The program is configured to at least facilitate forming a first message with at least a renewable energy storage system (RESS) command and a command security measure for the RESS command, transmitting the first message from the battery control unit to the battery charger, forming a second message in response to the first message with at least an RESS response and a response security measure for the RESS response, and transmitting the second message from the battery charger to the battery control unit. The computer-readable signal bearing media bears the program.

In accordance with a further exemplary embodiment of the present invention, a control system for a battery for a hybrid vehicle is provided. The control system comprises a battery control unit and a battery charger. The battery control unit is configured to at least facilitate forming a first message with at least a renewable energy storage system (RESS) command and a command security measure for the RESS command, transmitting the first message, and receiving a second message with at least an RESS response and a response security measure for the RESS response. The battery charger is coupled to the battery control unit, and is configured to at least facilitate receiving the first message from the battery control unit, forming the second message in response to the first message, and transmitting the second message to the battery control unit.

### BRIEF DESCRIPTION OF THE DRAWINGS

The present invention will hereinafter be described in conjunction with the following drawing figures, wherein like numerals denote like elements, and

FIG. 1 is a functional block diagram of a communications system including a battery control unit and a battery charger for maintaining and charging a renewable energy storage system (RESS) battery and a low voltage battery for a hybrid vehicle, in accordance with an exemplary embodiment of the present invention;

FIG. 2 is a functional block diagram of a computer system that can be utilized in connection with the communications system of FIG. 1, in accordance with an exemplary embodiment of the present invention;

FIG. 3 depicts a communications process for communications between a battery control unit and a battery charger for a hybrid vehicle, for example that can be used in connection with the communications system of FIG. 1 and the computer system of FIG. 2, in accordance with an exemplary embodiment of the present invention;

FIG. 4 depicts a step of the communications process of FIG. 3, namely the step of generating an encoded command message, in accordance with an exemplary embodiment of the present invention;

FIG. 5 depicts another step of the communications process of FIG. 3, namely the step of generating a first encoded response message, in accordance with an exemplary embodiment of the present invention;

FIG. 6 depicts another step of the communications process of FIG. 3, namely the step of generating a second encoded response message, in accordance with an exemplary embodiment of the present invention;

FIG. 7 is a table of various identifier values for an encoded command message, such as that formed by the process of FIG. 4, for a first encoded response message, such as that formed by the process of FIG. 5, and for a second encoded response message, such as that formed by the process of FIG. 6, along with a set of undefined values for security purposes, in accordance with an exemplary embodiment of the present invention;

FIG. 8 is a table of various RESS voltage command security enumeration values for an encoded command message, such as that formed by the process of FIG. 4, along with a set of undefined values for additional security, in accordance with an exemplary embodiment of the present invention;

FIG. 9 is a table of various RESS current command security enumeration values for an encoded command message, such as that formed by the process of FIG. 4, along with a set of undefined values for additional security, in accordance with an exemplary embodiment of the present invention;

FIG. 10 is a table of various low voltage security enumeration values for an encoded command message, such as that formed by the process of FIG. 4, along with a set of undefined values for additional security, in accordance with an exemplary embodiment of the present invention;

FIG. 11 depicts an exemplary encoded command message, such as that formed by the process of FIG. 4, in accordance with an exemplary embodiment of the present invention;

FIG. 12 is a table of various RESS voltage response security enumeration values for a first encoded response message, such as that formed by the process of FIG. 5, along with a set of undefined values for additional security, in accordance with an exemplary embodiment of the present invention;

FIG. 13 is a table of various RESS current response security enumeration values for a first encoded response message, such as that formed by the process of FIG. 5, along with a set of undefined values for additional security, in accordance with an exemplary embodiment of the present invention;

FIG. 14 is a table of various alternating current (AC) voltage security enumeration values for a first encoded response message, such as that formed by the process of FIG. 5, along with a set of undefined values for additional security, in accordance with an exemplary embodiment of the present invention;

FIG. 15 is a table of various alternating current (AC) current security enumeration values for a first encoded response message, such as that formed by the process of FIG. 5, along with a set of undefined values for additional security, in accordance with an exemplary embodiment of the present invention;

FIG. 16 depicts an exemplary first encoded response message, such as that formed by the process of FIG. 5, in accordance with an exemplary embodiment of the present invention;

FIG. 17 is a table of various low voltage response security enumeration values for a second encoded response message, such as that formed by the process of FIG. 6, along with a set of undefined values for additional security, in accordance with an exemplary embodiment of the present invention;

FIG. 18 is a table of various low voltage current response security enumeration values for a second encoded response message, such as that formed by the process of FIG. 6, along with a set of undefined values for additional security, in accordance with an exemplary embodiment of the present invention;

FIG. 19 is a table of various temperature security enumeration values for a second encoded response message, such as that formed by the process of FIG. 6, along with a set of undefined values for additional security, in accordance with an exemplary embodiment of the present invention; and

FIG. 20 depicts an exemplary second encoded response message, such as that formed by the process of FIG. 6, in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

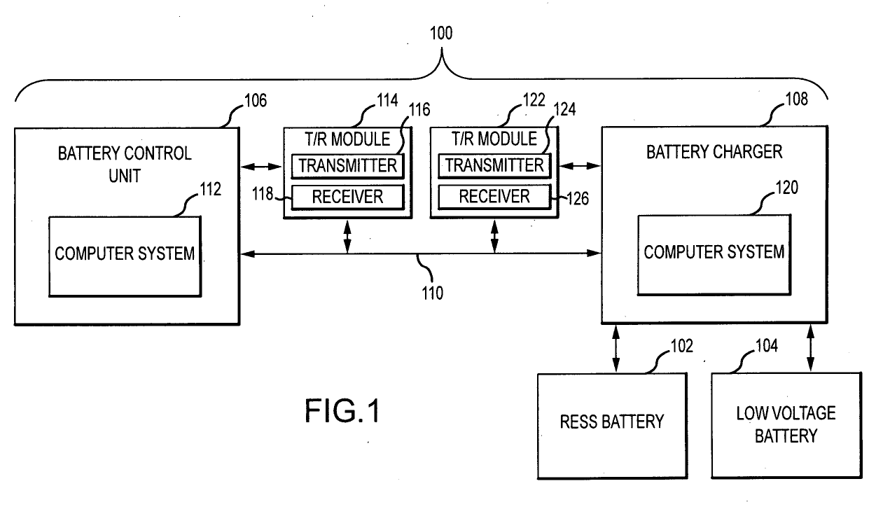

FIG. 1 is a functional block diagram of a communications system 100 for maintaining and charging a renewable energy storage system (RESS) battery 102 and a low voltage battery 104 for a hybrid vehicle, in accordance with an exemplary embodiment of the present invention. The RESS battery 102 depicted in FIG. 1 is preferably a lithium-ion battery, or another type of relatively high voltage battery that is capable of at least substantially powering the hybrid vehicle when operated in a battery operational mode. The low voltage battery 104 is a relatively lower voltage battery as compared with the RESS battery 102, and is preferably capable of operating a radio, instrument panel, navigation system, and/or other components of the hybrid vehicle.

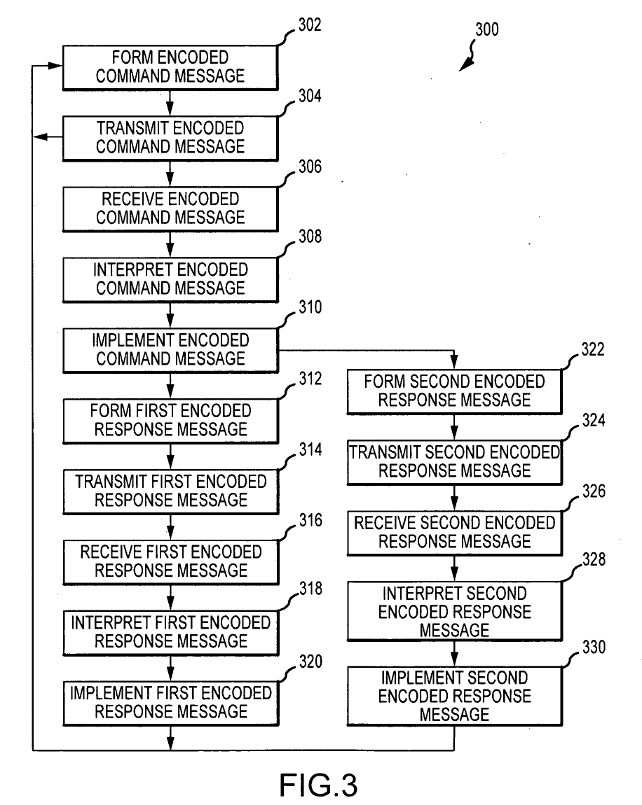

The communications system 100 includes a battery control unit 106 and a battery charger 108. The battery control unit 106 generates encoded command messages with instructions pertaining to the RESS battery 102 and the low voltage battery 104 for transmission to the battery charger 108, and also receives, interprets, and implements encoded response messages from the battery charger 108. The battery charger 108 receives, interprets, and implements the encoded command messages, and generates the encoded response messages in response thereto. The encoded command messages include instructions for the battery charger 108 for charging and maintaining the RESS battery 102 and the low voltage battery 104 and related inquiries. The encoded response messages include responses from the battery charger 108 to the instructions and inquiries of the encoded command messages. An exemplary embodiment of a communications process that can be used for communications between the RESS battery control unit 106 and the battery charger 108 that includes the above-referenced encoded command messages and encoded response messages will be described in greater detail further below in connection with FIG. 3.

As depicted in FIG. 1, the battery control unit 106 and the battery charger 108 are coupled, and are preferably interconnected, by a conventional data connection 110 as appropriate, through which the encoded command and response messages are transmitted. In various embodiments, the data connection 110 is a universal asynchronous receiver/transmitter (UART), or other internal connection (e.g. a bus connection) within the communications system 100. Various different types of data connections may be utilized. Also as depicted in FIG. 1, the battery control unit 106 and the battery charger 108 may be coupled to the data connection 110 directly and/or via respective first and second transmitter/receiver modules 114, 122.

In one such embodiment, the battery control unit 106 is coupled to the first transmitter/receiver module 114. The first transmitter/receiver module 114 includes a first transmitter 116 and a first receiver 118. The first transmitter 116 is configured to transmit the encoded command messages originating from the battery control unit 106 along the data connection 110 for ultimate use by the battery charger 108. The first receiver 118 is configured to receive the encoded response messages originating from the battery charger 108 for ultimate use by the battery control unit 106.

As depicted in FIG. 1, also in this embodiment, the battery charger 108 is coupled to the second transmitter/receiver module 122. The second transmitter/receiver module 122 includes a second transmitter 124 and a second receiver 126. The second receiver 126 is configured to receive the encoded data messages transmitted from the battery charger 108 to the battery control unit 106. The second transmitter 124 is configured to transmit the encoded response messages along the data connection 110 from the battery charger 108 to the battery control unit 106.

In certain embodiments, the battery control unit 106 and/or the battery charger 108 may also be directly coupled to the data connection 110, as is also shown in FIG. 1. For example, the battery control unit 106 and/or the battery charger 108 may include respective transmitters and/or receivers.

Also as depicted in FIG. 1, the battery control unit 106 and the battery charger 108 preferably include respective first and second computer systems 112, 120. In one embodiment, the first computer system 112 of the battery control unit 106 controls operations of the battery control unit 106 and, with it, at least facilitates the generation and transmission of the encoded command messages, as well as receiving, interpreting, and implementing the encoded response messages. Similarly, in this embodiment, the second computer system 120 of the battery charger 108 controls operations of the battery charger 108 and, with it, at least facilitates the generation and transmission of the encoded response messages as well as receiving, interpreting, and implementing the encoded command messages.

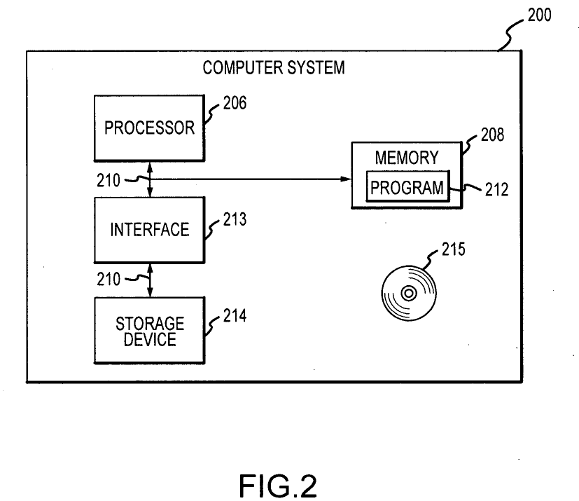

An exemplary embodiment of a computer system, which can be used for the first and second computer systems 112, 120 of the battery control unit 106 and the battery charger 108, respectively, will be discussed below in connection with FIG. 2. In a preferred embodiment, the battery control unit 106 and the battery charger 108 use different computer systems 112, 120. However, it will be appreciated that, in various other embodiments, the battery control unit 106 and the battery charger 108 may use one or more common computer systems. It will similarly be appreciated that the communications system 100 can be utilized in connection with any number of different types of computer systems and/or other devices or systems in various embodiments.

FIG. 2 is a functional block diagram of a computer system 200 that can be used in connection with the above-referenced first and second respective first and second computer systems 112, 120 of the battery control unit 106 and the battery charger 108 of the communications system 100 of FIG. 1, and that can be utilized in implementing the communications process described further below in connection with FIG. 3 and other processes and steps described herein, in accordance with an exemplary embodiment of the present invention. In one preferred embodiment, each of the battery control unit 106 and the battery charger 108 of FIG. 1 uses a different computer system 200. However, similar to the discussion above in connection with FIG. 1, this may vary in other embodiments.

In the embodiment depicted in FIG. 2, each computer system 200 includes a processor 206, a memory 208, a computer bus 210, an interface 213, and a storage device 214. The processor 206 performs the computation and control functions of the battery control unit 106 and/or the battery charger 108 or portions thereof, and may comprise any type of processor or multiple processors, single integrated circuits such as a microprocessor, or any suitable number of integrated circuit devices and/or circuit boards working in cooperation to accomplish the functions of a processing unit. During operation, the processor 206 executes one or more programs 212 preferably stored within the memory 208 and, as such, controls the general operation of the computer system 200.

The memory 208 stores a program or programs 212 that executes one or more embodiments of a communications process such as that described further below in connection with FIG. 3, and/or various steps thereof and/or other processes, such as those described elsewhere herein. The memory 208 can be any type of suitable memory. This would include the various types of dynamic random access memory (DRAM) such as SDRAM, the various types of static RAM (SRAM), and the various types of non-volatile memory (PROM, EPROM, and flash). It should be understood that the memory 208 may be a single type of memory component, or it may be composed of many different types of memory components. In addition, the memory 208 and the processor 206 may be distributed across several different computers that collectively comprise the computer system 200. For example, a portion of the memory 208 may reside on a computer within a particular apparatus or process, and another portion may reside on a remote computer.

The computer bus 210 serves to transmit programs, data, status and other information or signals between the various components of the computer system 200. The computer bus 210 can be any suitable physical or logical means of connecting computer systems and components. This includes, but is not limited to, direct hard-wired connections, fiber optics, infrared and wireless bus technologies.

The interface 213 allows communication to the computer system 200, for example from a system operator and/or another computer system, and can be implemented using any suitable method and apparatus. It can include one or more network interfaces to communicate within the communications system 100 of FIG. 1 and/or within or to other systems or components, one or more terminal interfaces to communicate with technicians, and one or more storage interfaces to connect to storage apparatuses such as the storage device 214.

The storage device 214 can be any suitable type of storage apparatus, including direct access storage devices such as hard disk drives, flash systems, floppy disk drives and optical disk drives. In one exemplary embodiment, the storage device 214 is a program product from which memory 208 can receive a program 212 that executes one or more embodiments of the communications process and/or steps thereof as described in greater detail further below. In one preferred embodiment, such a program product can be implemented as part of, inserted into, or otherwise coupled to the first and second computer systems 112, 120 of the battery control unit 106 and the battery charger 108, respectively, of the communications system 100 of FIG. 1. As shown in FIG. 2, the storage device 214 can comprise a disk drive device that uses disks 215 to store data. As one exemplary implementation, the computer system 200 may also utilize an Internet website, for example for providing or maintaining data or performing operations thereon.

It will be appreciated that while this exemplary embodiment is described in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks (e.g., disk 215), and transmission media such as digital and analog communication links. It will similarly be appreciated that the computer system 200 may also otherwise differ from the embodiment depicted in FIG. 2, for example in that the computer system 200 may be coupled to or may otherwise utilize one or more remote computer systems and/or other control systems.

FIG. 3 is a flowchart depicting a communications process 300 for communications between a battery control unit and a battery charger for a hybrid vehicle, in accordance with an exemplary embodiment of the present invention. In a preferred embodiment, the communications process 300 can be utilized in connection with the communications system 100 of FIG. 1 and the computer system 200 of FIG. 2. However, it will be appreciated that the communications process 300 can also be utilized in connection with any number of other different types of systems and/or devices.

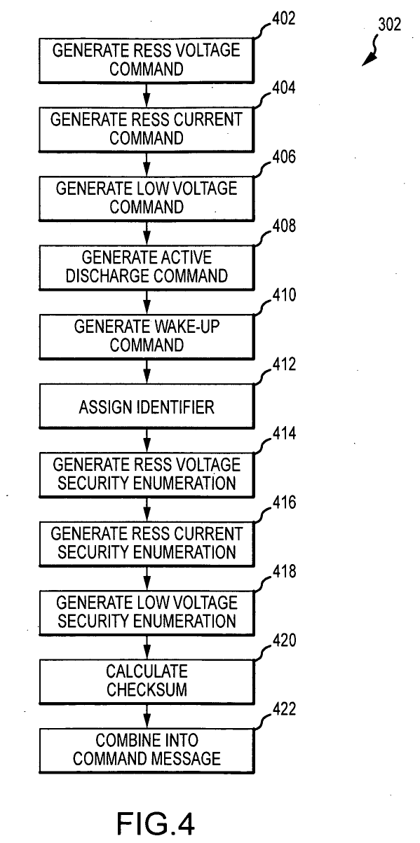

As depicted in FIG. 3, the communications process 300 begins with the step of forming an encoded command message (step 302). In a preferred embodiment, the encoded command message includes instructions for the battery charger 108 of FIG. 1 for charging and maintaining the RESS battery 102 and the low voltage battery 104 and related instructions and inquiries, and is formed using the first computer system 112 of the battery control unit 106 of FIG. 1. The encoded command message is preferably formed in step 302 to include various instructions pertaining to multiple batteries of the hybrid vehicle, such as the RESS battery 102 and the low voltage battery 104 of FIG. 1, and/or other non-depicted batteries. A detailed exemplary embodiment of this step 302 of forming the encoded command message is depicted in FIG. 4, and will be described further below in connection therewith; however, step 302 may vary in other embodiments.

The encoded data message is then transmitted (step 304), preferably from the battery control unit 106 of FIG. 1 along the data connection 110 of FIG. 1, for example via the first transmitter 116. Subsequently the encoded data message is received (step 306), preferably by the battery charger 108 of FIG. 1 via the second receiver 126. Upon receipt, the encoded command message is then interpreted (step 308) and implemented (step 310), preferably using the second computer system 120 of the battery charger 108 of FIG. 1. For example, the encoded command message may be implemented by charging the RESS battery 102 and the low voltage battery 104 appropriately in accordance with instructions provided in the encoded command message, by making appropriate adjustments pertaining to the RESS battery 102 and the low voltage battery 104, and by providing responsive information to requests provided in the encoded command message.

The implementation of the encoded command message in step 310 may also include appropriate remedial action based upon the interpretation of the encoded command message in step 308. For example, if there is an indication of a problem with one or more values in the encoded command message revealed through the interpretation of the encoded command message conducted in step 308, then such remedial action may include utilizing previous values from previous encoded messages in the implementation of the encoded command message in step 310.

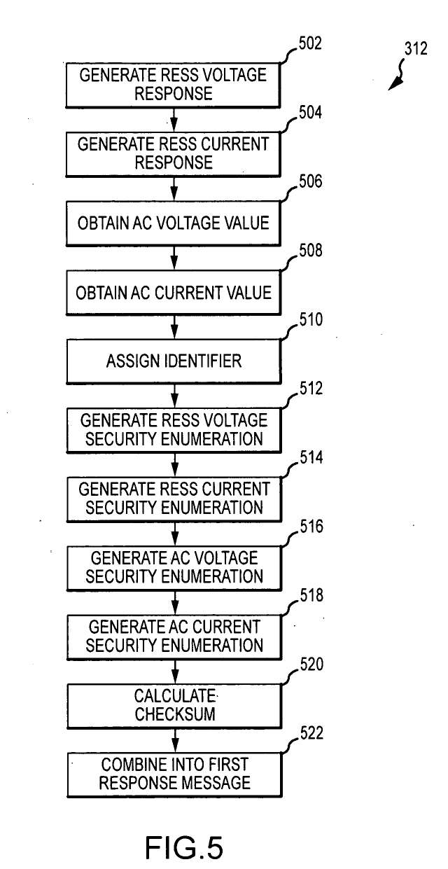

Next, a first encoded response message is formed (step 312). In a preferred embodiment, the first encoded response message includes responses to inquiries from the encoded command message pertaining to the RESS battery 102, and the first encoded response message is formed using the second computer system 120 of the battery charger 108 of FIG. 1. A detailed exemplary embodiment of this step 312 of forming the first encoded response message is depicted in FIG. 5, and will be described further below in connection therewith; however, step 312 may vary in other embodiments.

The first encoded response message is then transmitted (step 314), preferably from the battery charger 108 of FIG. 1 along the data connection 110 of FIG. 1, for example via the second transmitter 124. Subsequently the first encoded response message is received (step 316), preferably by the battery control unit 106 of FIG. 1 via the first receiver 118. Upon receipt, the first encoded response message is then interpreted (step 318) and implemented (step 320), preferably using the first computer system 112 of the battery control unit 106 of FIG. 1. For example, the first encoded response message may be implemented by formulating and sending new commands for the battery charger 108 with respect to the RESS battery 102 in subsequent command messages, among various other possible actions. The implementation of the first encoded response message in step 320 may also include appropriate remedial action based upon the interpretation of the first encoded response message in step 318.

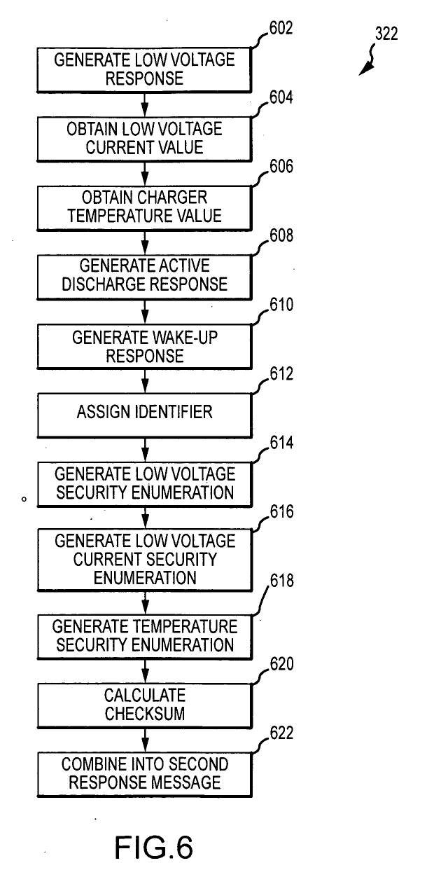

In addition, a second encoded response message is formed (step 322). In a preferred embodiment, the second encoded response message includes responses to inquiries from the encoded command message pertaining to the low voltage battery 104, and the first encoded response message is formed using the second computer system 120 of the battery charger 108 of FIG. 1. A detailed exemplary embodiment of this step 322 of forming the first encoded response message is depicted in FIG. 6, and will be described further below in connection therewith; however, step 322 may vary in other embodiments.

The second encoded response message is then transmitted (step 324), preferably from the battery charger 108 of FIG. 1 along the data connection 110 of FIG. 1, for example via the second transmitter 124. Subsequently the second encoded response message is received (step 326), preferably by the battery control unit 106 of FIG. 1 via the first receiver 118. Upon receipt, the second encoded response message is then interpreted (step 328) and implemented (step 330), preferably using the first computer system 112 of the battery control unit 106 of FIG. 1. For example, the second encoded response message may be implemented by formulating and sending new commands for the battery charger 108 with respect to the low voltage battery 104 in subsequent command messages, among various other possible actions. The implementation of the first encoded response message in step 320 may also include appropriate remedial action based upon the interpretation of the first encoded response message in step 318.

While steps 322-330 are described above as following steps 312-320, it will be appreciated that the order of these steps may vary. It will similarly be appreciated that the order of various other steps of the communications process 300 may similarly vary, regardless of the order in which such steps are depicted in FIG. 3 and/or described herein in connection therewith.

The process then repeats, preferably beginning with step 302, and new encoded command messages, first encoded response messages, and second encoded response messages are formed, transmitted, received, interpreted, and implemented. The steps of the communications process 300 preferably repeat continuously through various iterations, with each iteration resulting in the formation, transmission, receipt, interpretation, and implementation of a different encoded command message corresponding to a different point in time, along with a different first encoded response message and second encoded response message in response thereto. In a preferred embodiment, the encoded command messages, first response messages, and second response messages are continuously formed, transmitted, received, interpreted, and implemented in sequence in accordance with this process.

It will be appreciated that various steps of different iterations of the steps of the communications process 300 may overlap. For example, as indicated by the two arrows following step 304 depicted in FIG. 3, once a particular encoded command message is transmitted in step 304, a new command message may be formed in a subsequent iteration of step 302, even while the remaining steps of the prior iteration (such as the receipt of the encoded command message in step 306, the formation of the first encoded response message in step 312, the formation of the second encoded response message in step 322, and so on) are still ongoing. It will be appreciated that various other steps may also overlap in and between different iterations, and that new iterations may also begin at various other points in the communications process 300 of FIG. 3.

FIG. 4 is a flowchart depicting, in greater detail, the above-referenced step 302 of the communications process 300 of FIG. 3, namely the step of forming an encoded command message, in accordance with an exemplary embodiment of the present invention. As depicted in FIG. 4, the formation of the encoded command message in this exemplary embodiment begins with the step of generating an RESS voltage command (step 402). In a preferred embodiment, the RESS voltage command comprises one or more instructions for the battery charger 108 of FIG. 1 with respect to a calibration of voltage for the RESS battery 102, such as a target voltage level for the RESS battery 102. The RESS voltage command is preferably formed using the first computer system 112 of the battery control unit 106 of FIG. 1.

Next, an RESS current command is generated (step 404). In a preferred embodiment, the RESS current command comprises one or more instructions for the battery charger 108 of FIG. 1 with respect to a calibration of current for the RESS battery 102, such as a target current level for the RESS battery 102. The RESS current command is also preferably formed using the first computer system 112 of the battery control unit 106 of FIG. 1.

In addition, a low voltage command is generated (step 406). In a preferred embodiment, the low voltage command comprises one or more instructions for the battery charger 108 of FIG. 1 with respect to a calibration of voltage for the low voltage battery 104. The low voltage command is also preferably formed using the first computer system 112 of the battery control unit 106 of FIG. 1.

An active discharge command is also generated (step 408). In a preferred embodiment, the active discharge command comprises one or more instructions for the battery charger 108 of FIG. 1 with respect to any desired active discharge for the RESS battery 102 and/or the low voltage battery 104. The active discharge command is also preferably formed using the first computer system 112 of the battery control unit 106 of FIG. 1.

A wake-up command is also generated (step 410). In a preferred embodiment, the wake-up command comprises one or more instructions for the battery charger 108 of FIG. 1 notifying the battery charger 108 that it will now need to provide actions and responses pursuant to the encoded command message. The wake-up command is also preferably formed using the first computer system 112 of the battery control unit 106 of FIG. 1.

An identifier is also assigned for the encoded command message (step 412). The identifier is assigned so that the encoded command message can be properly identified out of a sequence of messages after it is received, for example by the battery charger 108 via the second receiver 126 of FIG. 1. The identifier is preferably assigned using the first computer system 112 of the battery control unit 106 of FIG. 1.

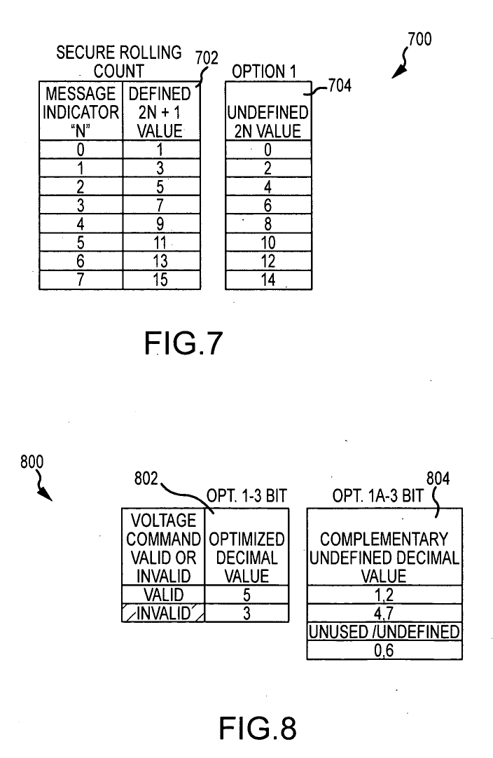

In one preferred embodiment, the identifier utilizes a rolling count with a four bit enumeration, such as that depicted in FIG. 7. Specifically, FIG. 7 provides a table 700 of various identifier values 702 for the encoded command message, dependent on where the encoded command message fits in a sequence of messages (for example, with respect to a sequence of command messages over time, through multiple iterations of the steps of the communications process 300 of FIG. 3), in accordance with an exemplary embodiment of the present invention. In the depicted embodiment, a “2N+1 rolling count” is used.

For example, in the depicted embodiment, if the encoded command message is the first message in a particular sequence, then the identifier for the command message is assigned an identifier value 702 equal to one, or 0001 in binary form, in the depicted embodiment. Likewise: (1) if the encoded command message is the second message in the sequence, the identifier for the command message is assigned an identifier value 702 equal to three, or 0011 in binary form; (2) if the encoded command message is the third message in the sequence, the identifier for the command message is assigned an identifier value 702 equal to five, or 0101 in binary form; (3) if the encoded command message is the fourth message in the sequence, the identifier for the command message is assigned an identifier value 702 equal to seven, or 0111 in binary form; (4) if the encoded command message is the fifth message in the sequence, the identifier for the command message is assigned an identifier value 702 equal to nine, or 1001 in binary form; (5) if the encoded command message is the sixth message in the sequence, the identifier for the command message is assigned an identifier value 702 equal to eleven, or 1011 in binary form; (6) if the encoded command message is the seventh message in the sequence, the identifier for the command message is assigned an identifier value 702 equal to thirteen, or 1101 in binary form; and (7) if the encoded command message is the eighth message in the sequence, the identifier for the command message is assigned an identifier value 702 equal to fifteen, or 1111 in binary form. It will be appreciated that the identifier values 702, and/or the order thereof, may vary in different embodiments.

FIG. 7 also depicts a set of undefined values 704 for security purposes in accordance with an exemplary embodiment of the present invention. For example, if it is determined in the interpretation of the encoded command message (such as in step 308 of the communications process 300 of FIG. 3) that an identifier for the encoded command message has a value that is equal to any of the undefined values 704, this serves as an indication that an error has occurred, and appropriate remedial action can be taken. In the depicted embodiment, the undefined values 704 include the following values: zero (0000 in binary form), two (0010 in binary form), four (0100 in binary form), six (0110 in binary form), eight (1000 in binary form), ten (1010 in binary form), twelve (1100 in binary form), and fourteen (1110 in binary form). However, it will be appreciated that the undefined values 704 may vary in other embodiments.

Returning now to FIG. 4, various security enumerations are also generated for the encoded command message (steps 414-418). These security enumerations provide security for values included in the encoded command message. Preferably, each security enumeration is assigned a value from a respective plurality of values that are each at least two bit errors removed from one another in binary form, to serve as protection against memory fault errors, arithmetic logic unit errors, and/or other potential errors in the security enumeration values.

Specifically, an RESS voltage command security enumeration is generated (step 414). The RESS voltage command security enumeration provides a measure of security as to whether the value for the RESS voltage command generated in step 402 is valid. In a preferred embodiment, the RESS voltage command security enumeration uses possible values that are at least two bit errors removed from one another in binary form. The RESS voltage command security enumeration is also preferably generated using the first computer system 112 of the battery control unit 106 of FIG. 1.

In one preferred embodiment, the RESS voltage command security enumeration is a three bit enumeration, such as that depicted in FIG. 8. Specifically, FIG. 8 provides a table 800 of various RESS voltage command security enumeration values 802 for the encoded command message, dependent on whether the RESS voltage command is deemed to be valid or invalid, in accordance with an exemplary embodiment of the present invention.

For example, in the depicted embodiment, if the RESS voltage command is determined to be valid, then the RESS voltage command security enumeration for the encoded command message is assigned a value equal to five, or 101 in binary form. Conversely, if the RESS voltage command is determined to be invalid, then the RESS voltage command security enumeration for the encoded command message is assigned a value equal to three, or 011 in binary form. These values not only protect against memory fault errors that might cause a single shift in a binary digit value in the security enumeration, but also protect against leftward or rightward shifts in multiple binary digit values (for example, that could be potentially caused by an arithmetic logic unit error), and thus provide enhanced security. It will be appreciated that these RESS voltage command security enumeration values 802, and/or the order thereof, may vary in different embodiments.

FIG. 8 also depicts a set of undefined values 804 for the RESS voltage command security enumerations, for additional security. For example, if it is determined in the interpretation of the encoded command message (such as in step 308 of the communications process 300 of FIG. 3) that an RESS voltage command security enumeration has a value that is equal to any of the undefined values 804, this serves as an indication that an error has occurred, and appropriate remedial action can be taken. In the depicted embodiment, the undefined values 804 include the following values: one (001 in binary form), two (010 in binary form), four (100 in binary form), seven (111 in binary form), zero (000 in binary form), and six (110 in binary form). However, it will be appreciated that the undefined values 804 may vary in other embodiments.

In addition, and returning again to FIG. 4, an RESS current command security enumeration is generated (step 416). The RESS current command security enumeration provides a measure of security as to whether the value for the RESS current command generated in step 404 is valid. In a preferred embodiment, the RESS current command security enumeration uses possible values that are at least two bit errors removed from one another in binary form. The RESS current command security enumeration is also preferably generated using the first computer system 112 of the battery control unit 106 of FIG. 1.

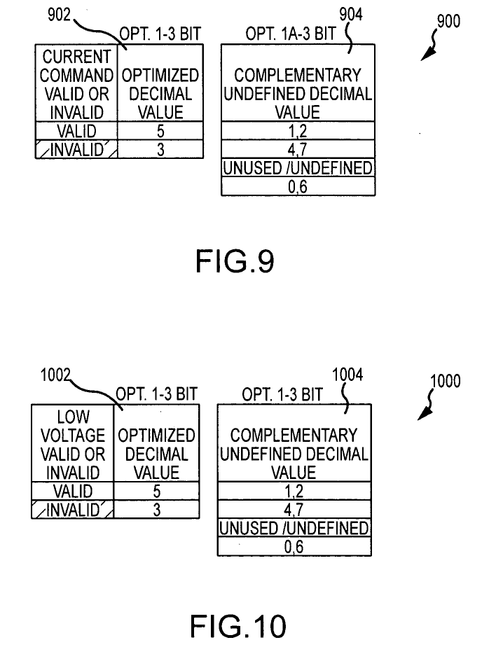

In one preferred embodiment, the RESS current command security enumeration is a three bit enumeration, such as that depicted in FIG. 9. Specifically, FIG. 9 provides a table 900 of various RESS current command security enumeration values 902 for the encoded command message, dependent on whether the RESS current command is deemed to be valid or invalid, in accordance with an exemplary embodiment of the present invention.

For example, in the depicted embodiment, if the RESS current command is determined to be valid, then the RESS current command security enumeration for the encoded command message is assigned a value equal to five, or 101 in binary form. Conversely, if the RESS current command is determined to be invalid, then the RESS current command security enumeration for the encoded command message is assigned a value equal to three, or 011 in binary form. These values not only protect against memory fault errors that might cause a single shift in a binary digit value in the security enumeration, but also protect against leftward or rightward shifts in multiple binary digit values (for example, that could be potentially caused by an arithmetic logic unit error), and thus provide enhanced security. It will be appreciated that these RESS current command security enumeration values 902, and/or the order thereof, may vary in different embodiments. For example, the RESS current command security enumeration values 902 may differ from the RESS voltage command security enumeration values used in the encoded command message.

FIG. 9 also depicts a set of undefined values 904 for the RESS current command security enumerations, for additional security. For example, if it is determined in the interpretation of the encoded command message (such as in step 308 of the communications process 300 of FIG. 3) that an RESS current command security enumeration has a value that is equal to any of the undefined values 904, this serves as an indication that an error has occurred, and appropriate remedial action can be taken. In the depicted embodiment, the undefined values 904 include the following values: one (001 in binary form), two (010 in binary form), four (100 in binary form), seven (111 in binary form), zero (000 in binary form), and six (110 in binary form). However, it will be appreciated that the undefined values 904 may vary in other embodiments.

Also, and returning again to FIG. 4, a low voltage security enumeration is generated (step 418). The low voltage security enumeration provides a measure of security as to whether the value for the low voltage command generated in step 406 is valid. In a preferred embodiment, the low voltage security enumeration uses possible values that are at least two bit errors removed from one another in binary form. The low voltage security enumeration is also preferably generated using the first computer system 112 of the battery control unit 106 of FIG. 1.

In one preferred embodiment, the low voltage security enumeration is a three bit enumeration, such as that depicted in FIG. 10. Specifically, FIG. 10 provides a table 1000 of various low voltage security enumeration values 1002 for the encoded command message, dependent on whether the low voltage command is deemed to be valid or invalid, in accordance with an exemplary embodiment of the present invention.

For example, in the depicted embodiment, if the low voltage command is determined to be valid, then the low voltage security enumeration for the encoded command message is assigned a value equal to five, or 101 in binary form. Conversely, if the low voltage command is determined to be invalid, then the low voltage security enumeration for the encoded command message is assigned a value equal to three, or 011 in binary form. These values not only protect against memory fault errors that might cause a single shift in a binary digit value in the security enumeration, but also protect against leftward or rightward shifts in multiple binary digit values (for example, that could be potentially caused by an arithmetic logic unit error), and thus provide enhanced security. It will be appreciated that these low voltage security enumeration values 1002, and/or the order thereof, may vary in different embodiments. For example, the low voltage security enumeration values 1002 may differ from the RESS voltage command security enumeration values and/or the RESS current command security enumerations used in the encoded command message.

FIG. 10 also depicts a set of undefined values 1004 for the low voltage security enumerations, for additional security. For example, if it is determined in the interpretation of the encoded command message (such as in step 308 of the communications process 300 of FIG. 3) that a low voltage security enumeration has a value that is equal to any of the undefined values 1004, this serves as an indication that an error has occurred, and appropriate remedial action can be taken. In the depicted embodiment, the undefined values 1004 include the following values: one (001 in binary form), two (010 in binary form), four (100 in binary form), seven (111 in binary form), zero (000 in binary form), and six (110 in binary form). However, it will be appreciated that the undefined values 1004 may vary in other embodiments.

In addition, a checksum is calculated (step 420). In a preferred embodiment, the checksum is calculated so as to include each of the RESS voltage command, the RESS current command, the low voltage command, the active discharge command, the wake-up command, the identifier, the RESS voltage command security enumeration, the RESS current command security enumeration, and the low voltage security enumeration. However, this may vary in other embodiments. Next, each of the RESS voltage command, the RESS current command, the low voltage command, the active discharge command, the wake-up command, the identifier, the RESS voltage command security enumeration, the RESS current command security enumeration, the low voltage security enumeration, and the checksum are combined together to complete the formation of the encoded command message (step 422).

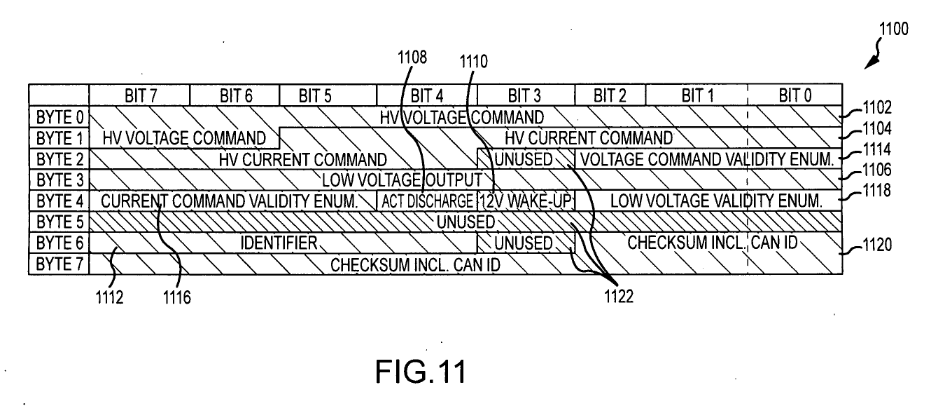

FIG. 11 depicts an exemplary encoded command message 1100 that can be generated pursuant to the communications process 300 of FIG. 3 (and, specifically, pursuant to step 302, as described in greater detail in connection with the process of FIG. 4), in accordance with an exemplary embodiment of the present invention. In the depicted embodiment, the encoded command message 1100 includes a ten bit RESS voltage command 1102, a ten bit RESS current command 1104, an eight bit low voltage command 1106, a one bit active discharge command 1108, a one bit wake-up command 1110, a four bit identifier 1112, a three bit RESS voltage command security enumeration 1114, a three bit RESS current command security enumeration 1116, a three bit low voltage security enumeration 1118, and an eleven bit checksum 1120.

The encoded command message 1100 thus includes enhanced security protections for the RESS voltage command, the RESS current command, and the low voltage security command due to the relative importance of these commands, in addition to providing the checksum that provides additional protections for each of the commands. The encoded message 1100 accomplishes this while still minimizing the amount of information and messages needed for the communications. For example, redundant messages are not required for security. As a result, throughput is also potentially reduced in the communications between the battery control unit 106 and the battery charger 108, thereby also potentially reducing traffic on the data connection 110 and/or potentially reducing software and/or other overhead.

In the depicted embodiment, the exemplary encoded command message 1100 further includes ten unused bits 1122, for example for use in the event that additional information, data, and/or security enumerations may be required. It will be appreciated that the encoded command message may differ from the exemplary encoded command message 1100 depicted in FIG. 11. It will similarly be appreciated that the steps depicted in FIG. 4 and/or described above may differ, and/or may be performed in a different order than that depicted and/or described.

FIG. 5 is a flowchart depicting, in greater detail, the above-referenced step 312 of the communications process 300 of FIG. 3, namely the step of forming a first encoded response message, in accordance with an exemplary embodiment of the present invention. As depicted in FIG. 5, the formation of the first encoded response message in this exemplary embodiment begins with the step of generating an RESS voltage response (step 502). In a preferred embodiment, the RESS voltage response comprises one or more responses from the battery charger 108 of FIG. 1 to the encoded command message with respect to a measure of voltage for the RESS battery 102. The RESS voltage response is preferably formed using the second computer system 120 of the battery charger 108 of FIG. 1.

Next, an RESS current response is generated (step 504). In a preferred embodiment, the RESS current response comprises one or more responses from the battery charger 108 of FIG. 1 to the encoded command message with respect to a measure of current for the RESS battery 102. The RESS current response is also preferably formed using the second computer system 120 of the battery charger 108 of FIG. 1.

In addition, an alternating current (AC) voltage value is generated (step 506). In a preferred embodiment, the AC voltage value comprises one or more responses from the battery charger 108 of FIG. 1 to the encoded command message with respect to a measure of AC voltage for the RESS battery 102 and/or the low voltage battery 104. The AC voltage value is also preferably formed using the second computer system 120 of the battery charger 108 of FIG. 1.

An AC current value is also generated (step 508). In a preferred embodiment, the AC current value comprises one or more responses from the battery charger 108 of FIG. 1 to the encoded command message with respect to a measure of AC current for the RESS battery 102 and/or the low voltage battery 104. The AC current value is also preferably formed using the second computer system 120 of the battery charger 108 of FIG. 1.

An identifier is also assigned for the first encoded response message (step 510). The identifier is assigned so that the first encoded response message can be properly identified out of a sequence of messages after it is received, for example by the battery charger 108 via the second receiver 126 of FIG. 1. The identifier is preferably assigned using the second computer system 120 of the battery charger 108 of FIG. 1. In one preferred embodiment, the identifier utilizes a rolling count with a four bit enumeration, such as that depicted in FIG. 7 and described above in connection therewith. In this embodiment, the first encoded response message uses the same table 700 of identifier values 702 as the encoded command message, dependent on where the first encoded response message fits in a sequence of messages (for example, with respect to a sequence of response messages over time, through multiple iterations of the steps of the communications process 300 of FIG. 3), in accordance with an exemplary embodiment of the present invention. As such, in this embodiment, a similar “2N+1 rolling count” is used. However, this may vary in other embodiments. For example, the first encoded response message may use a different counting sequence or one or more other techniques.

Returning now to FIG. 5, various security enumerations are also generated for the first encoded response message (steps 512-518). These security enumerations provide security for values included in the first encoded response message. Preferably, each security enumeration is assigned a value from a respective plurality of values that are each at least two bit errors removed from one another in binary form, to serve as protection against memory fault errors, arithmetic logic unit errors, and/or other potential errors in the security enumeration values.

Specifically, an RESS voltage response security enumeration is generated (step 512). The RESS voltage response security enumeration provides a measure of security as to whether the value for the RESS voltage response generated in step 502 is valid. In a preferred embodiment, the RESS voltage response security enumeration uses possible values that are at least two bit errors removed from one another in binary form. The RESS voltage response security enumeration is also preferably generated using the second computer system 120 of the battery charger 108 of FIG. 1.

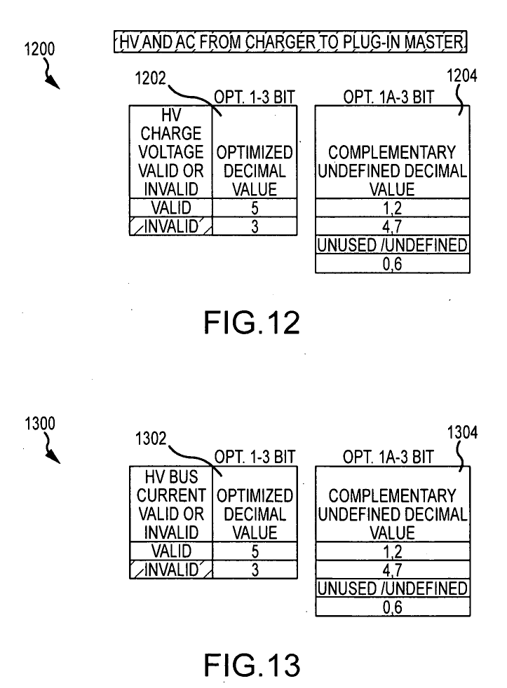

In one preferred embodiment, the RESS voltage response security enumeration is a three bit enumeration, such as that depicted in FIG. 12. Specifically, FIG. 12 provides a table 1200 of various RESS voltage response security enumeration values 1202 for the first encoded response message, dependent on whether the RESS voltage response is deemed to be valid or invalid, in accordance with an exemplary embodiment of the present invention.

For example, in the depicted embodiment, if the RESS voltage response is determined to be valid, then the RESS voltage response security enumeration for the first encoded response message is assigned a value equal to five, or 101 in binary form. Conversely, if the RESS voltage response is determined to be invalid, then the RESS voltage response security enumeration for the first encoded response message is assigned a value equal to three, or 011 in binary form. These values not only protect against memory fault errors that might cause a single shift in a binary digit value in the security enumeration, but also protect against leftward or rightward shifts in multiple binary digit values (for example, that could be potentially caused by an arithmetic logic unit error), and thus provide enhanced security. It will be appreciated that these RESS voltage response security enumeration values 1202, and/or the order thereof, may vary in different embodiments.

FIG. 12 also depicts a set of undefined values 1204 for the RESS voltage response security enumerations, for additional security. For example, if it is determined in the interpretation of the first encoded response message (such as in step 318 of the communications process 300 of FIG. 3) that an RESS voltage response security enumeration has a value that is equal to any of the undefined values 1204, this serves as an indication that an error has occurred, and appropriate remedial action can be taken. In the depicted embodiment, the undefined values 1204 include the following values: one (001 in binary form), two (010 in binary form), four (100 in binary form), seven (111 in binary form), zero (000 in binary form), and six (110 in binary form). However, it will be appreciated that the undefined values 1204 may vary in other embodiments.

In addition, and returning again to FIG. 5, an RESS current response security enumeration is generated (step 514). The RESS current response security enumeration provides a measure of security as to whether the value for the RESS current response generated in step 504 is valid. In a preferred embodiment, the RESS current response security enumeration uses possible values that are at least two bit errors removed from one another in binary form. The RESS current response security enumeration is also preferably generated using the second computer system 120 of the battery charger 108 of FIG. 1.

In one preferred embodiment, the RESS current response security enumeration is a three bit enumeration, such as that depicted in FIG. 13. Specifically, FIG. 13 provides a table 1300 of various RESS current response security enumeration values 1302 for the first encoded response message, dependent on whether the RESS current response is deemed to be valid or invalid, in accordance with an exemplary embodiment of the present invention.

For example, in the depicted embodiment, if the RESS current response is determined to be valid, then the RESS current response security enumeration for the first encoded response message is assigned a value equal to five, or 101 in binary form. Conversely, if the RESS current response is determined to be invalid, then the RESS current response security enumeration for the first encoded response message is assigned a value equal to three, or 011 in binary form. These values not only protect against memory fault errors that might cause a single shift in a binary digit value in the security enumeration, but also protect against leftward or rightward shifts in multiple binary digit values (for example, that could be potentially caused by an arithmetic logic unit error), and thus provide enhanced security. It will be appreciated that these RESS current response security enumeration values 1302, and/or the order thereof, may vary in different embodiments. For example, the RESS current response security enumeration values 1302 may differ from the RESS voltage response security enumeration values used in the first encoded response message.

FIG. 13 also depicts a set of undefined values 1304 for the RESS current response security enumerations, for additional security. For example, if it is determined in the interpretation of the first encoded response message (such as in step 318 of the communications process 300 of FIG. 3) that an RESS current response security enumeration has a value that is equal to any of the undefined values 1304, this serves as an indication that an error has occurred, and appropriate remedial action can be taken. In the depicted embodiment, the undefined values 1304 include the following values: one (001 in binary form), two (010 in binary form), four (100 in binary form), seven (111 in binary form), zero (000 in binary form), and six (110 in binary form). However, it will be appreciated that the undefined values 1304 may vary in other embodiments.

Also, and returning again to FIG. 5, an AC voltage security enumeration is generated (step 516). The AC voltage security enumeration provides a measure of security as to whether the value for the AC voltage value generated in step 506 is valid. In a preferred embodiment, the AC voltage security enumeration uses possible values that are at least two bit errors removed from one another in binary form. The AC voltage security enumeration is also preferably generated using the second computer system 120 of the battery charger 108 of FIG. 1.

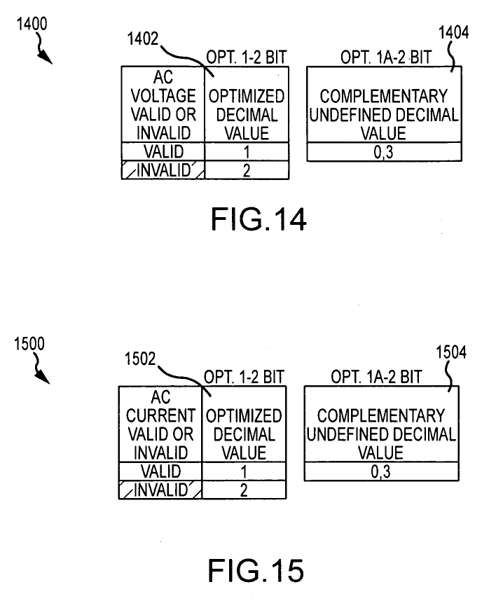

In one preferred embodiment, the AC voltage security enumeration is a two bit enumeration, such as that depicted in FIG. 14. Specifically, FIG. 14 provides a table 1400 of various AC voltage security enumeration values 1402 for the first encoded response message, dependent on whether the AC voltage value is deemed to be valid or invalid, in accordance with an exemplary embodiment of the present invention.

For example, in the depicted embodiment, if the AC voltage value is determined to be valid, then the AC voltage security enumeration for the first encoded response message is assigned a value equal to one, or 01 in binary form. Conversely, if the AC voltage value is determined to be invalid, then the AC voltage security enumeration for the first encoded response message is assigned a value equal to two, or 10 in binary form. These values protect against certain memory fault errors that could result in one binary digit changing to another, while otherwise minimizing the number of binary digits required for this security enumeration. It will be appreciated that these AC voltage security enumeration values 1402, and/or the order thereof, may vary in different embodiments. For example, the AC voltage security enumeration values 1402 may differ from the RESS voltage response security enumeration values and/or the RESS current response security enumerations used in the first encoded response message.

FIG. 14 also depicts a set of undefined values 1404 for the AC voltage security enumerations, for additional security. For example, if it is determined in the interpretation of the first encoded response message (such as in step 318 of the communications process 300 of FIG. 3) that an AC voltage security enumeration has a value that is equal to any of the undefined values 1404, this serves as an indication that an error has occurred, and appropriate remedial action can be taken. In the depicted embodiment, the undefined values 1404 include the following values: zero (00 in binary form) and three (11 in binary form). However, it will be appreciated that the undefined values 1404 may vary in other embodiments.

Returning again to FIG. 5, an AC current security enumeration is also generated (step 518). The AC current security enumeration provides a measure of security as to whether the value for the AC current value generated in step 508 is valid. In a preferred embodiment, the AC current security enumeration uses possible values that are at least two bit errors removed from one another in binary form. The AC current security enumeration is also preferably generated using the second computer system 120 of the battery charger 108 of FIG. 1.

In one preferred embodiment, the AC current security enumeration is a two bit enumeration, such as that depicted in FIG. 15. Specifically, FIG. 15 provides a table 1500 of various AC current security enumeration values 1502 for the first encoded response message, dependent on whether the AC current value is deemed to be valid or invalid, in accordance with an exemplary embodiment of the present invention.

For example, in the depicted embodiment, if the AC current value is determined to be valid, then the AC current security enumeration for the first encoded response message is assigned a value equal to one, or 01 in binary form. Conversely, if the AC current value is determined to be invalid, then the AC current security enumeration for the first encoded response message is assigned a value equal to two, or 10 in binary form. These values protect against certain memory fault errors that could result in one binary digit changing to another, while otherwise minimizing the number of binary digits required for this security enumeration. It will be appreciated that these AC current security enumeration values 1502, and/or the order thereof, may vary in different embodiments. For example, the AC current security enumeration values 1502 may differ from the RESS voltage response security enumeration values, the RESS current response security enumerations, and/or the AC voltage security enumerations used in the first encoded response message.

FIG. 15 also depicts a set of undefined values 1504 for the AC current security enumerations, for additional security. For example, if it is determined in the interpretation of the first encoded response message (such as in step 318 of the communications process 300 of FIG. 3) that an AC current security enumeration has a value that is equal to any of the undefined values 1504, this serves as an indication that an error has occurred, and appropriate remedial action can be taken. In the depicted embodiment, the undefined values 1404 include the following values: zero (00 in binary form) and three (11 in binary form). However, it will be appreciated that the undefined values 1404 may vary in other embodiments.

In addition, a checksum is calculated (step 520). In a preferred embodiment, the checksum is calculated so as to include each of the RESS voltage response, the RESS current response, the AC voltage value, the AC current value, the identifier, the RESS voltage response security enumeration, the RESS current response security enumeration, the AC voltage security enumeration, and the AC current security enumeration. However, this may vary in other embodiments.

Next, each of the RESS voltage response, the RESS current response, the AC voltage value, the AC current value, the identifier, the RESS voltage response security enumeration, the RESS current response security enumeration, the AC voltage security enumeration, the RESS current response security enumeration, and the checksum are combined together to complete the formation of the first encoded response message (step 522).

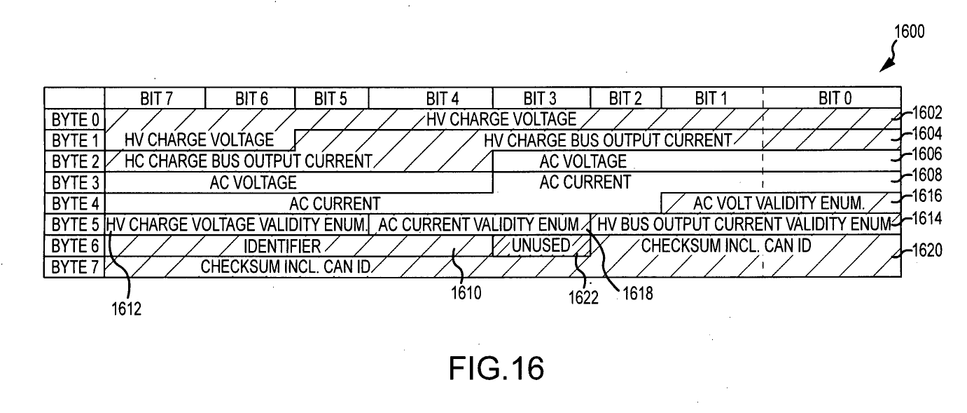

FIG. 16 depicts an exemplary first encoded response message 1600 that can be generated pursuant to the communications process 300 of FIG. 3 (and, specifically, pursuant to step 312, described in greater detail in connection with the process of FIG. 5), in accordance with an exemplary embodiment of the present invention. In the depicted embodiment, the first encoded response message 1600 includes a ten bit RESS voltage response 1602, a ten bit RESS current response 1604, an eight bit AC voltage value 1606, a ten bit AC current value 1608, a four bit identifier 1610, a three bit RESS voltage response security enumeration 1612, a three bit RESS current response security enumeration 1614, a two bit AC voltage security enumeration 1616, a two bit AC current security enumeration 1618, and an eleven bit checksum 1620.

The first encoded response message 1600 thus includes security protections for the AC voltage response and the AC current response, and enhanced security protections for the RESS voltage response and the RESS current response due to the relative importance of these responses, in addition to providing the checksum that provides additional protections for each of the responses. The first encoded response message 1600 accomplishes this while still minimizing the amount of information and messages needed for the communications. For example, redundant messages are not required for security. As a result, throughput is also potentially reduced in the communications between the battery control unit 106 and the battery charger 108, thereby also potentially reducing traffic on the data connection 110 and/or potentially reducing software and/or other overhead.

In the depicted embodiment, the exemplary first encoded response message 1600 further includes an unused bit 1622, for example for use in the event that additional information, data, and/or security enumerations may be required. It will be appreciated that the encoded command message may differ from the exemplary encoded command message 1600 depicted in FIG. 16. It will similarly be appreciated that the steps depicted in FIG. 5 and/or described above may differ, and/or may be performed in a different order than that depicted and/or described.

FIG. 6 is a flowchart depicting, in greater detail, the above-referenced step 322 of the communications process 300 of FIG. 3, namely the step of forming a second encoded response message, in accordance with an exemplary embodiment of the present invention. As depicted in FIG. 6, the formation of the second encoded response message in this exemplary embodiment begins with the step of generating a low voltage response (step 602). In a preferred embodiment, the low voltage response comprises one or more responses from the battery charger 108 of FIG. 1 to the encoded command message with respect to a measure of voltage for the low voltage battery 104. The low voltage response is preferably formed using the second computer system 120 of the battery charger 108 of FIG. 1.

Next, a low voltage current response is generated (step 604). In a preferred embodiment, the low voltage current response comprises one or more responses from the battery charger 108 of FIG. 1 to the encoded command message with respect to a measure of current for the low voltage battery 104. The low voltage current response is also preferably formed using the second computer system 120 of the battery charger 108 of FIG. 1.

In addition, a charger temperature value is obtained (step 606). In a preferred embodiment, the charger temperature value comprises a measure of the temperature of the battery charger 108 of FIG. 1. The charger temperature value is also preferably formed using the second computer system 120 of the battery charger 108 of FIG. 1.

An active discharge response is also generated (step 608). In a preferred embodiment, the active discharge response comprises one or more responses from the battery charger 108 of FIG. 1 to the encoded command message with respect to an active discharge command therefrom (for example, as generated in step 408 of the process of FIG. 4). The active discharge response is also preferably formed using the second computer system 120 of the battery charger 108 of FIG. 1.

Similarly, a wake-up response is also generated (step 610). In a preferred embodiment, the wake-up response comprises one or more responses from the battery charger 108 of FIG. 1 to the encoded command message with respect to a wake-up command therefrom (for example, as generated in step 410 of the process of FIG. 4). The wake-up response is also preferably formed using the second computer system 120 of the battery charger 108 of FIG. 1

An identifier is also assigned for the second encoded response message (step 612). The index is assigned so that the second encoded response message can be properly identified out of a sequence of messages after it is received, for example by the battery charger 108 via the second receiver 126 of FIG. 1. The identifier is preferably assigned using the second computer system 120 of the battery charger 108 of FIG. 1. In one preferred embodiment, the identifier utilizes a rolling count with a four bit enumeration, such as that depicted in FIG. 7 and described above in connection therewith. In this embodiment, the second encoded response message uses the same table 700 of identifier values 702 as the encoded command message, dependent on where the second encoded response message fits in a sequence of messages (for example, with respect to a sequence of response messages over time, through multiple iterations of the steps of the communications process 300 of FIG. 3), in accordance with an exemplary embodiment of the present invention. As such, in this embodiment, a similar “2N+1 rolling count” is used. However, this may vary in other embodiments. For example, the second encoded response message may use a different counting sequence or other technique for its identifier.

Returning now to FIG. 6, various security enumerations are also generated for the second encoded response message (steps 614-618). These security enumerations provide security for values included in the second encoded response message. Preferably, each security enumeration is assigned a value from a respective plurality of values that are each at least two bit errors removed from one another in binary form, to serve as protection against memory fault errors, arithmetic logic unit errors, and/or other potential errors in the security enumeration values.

Specifically, a low voltage response security enumeration is generated (step 614). The low voltage response security enumeration provides a measure of security as to whether the value for the low voltage response generated in step 602 is valid. In a preferred embodiment, the low voltage response security enumeration uses possible values that are at least two bit errors removed from one another in binary form. The low voltage response security enumeration is also preferably generated using the second computer system 120 of the battery charger 108 of FIG. 1.

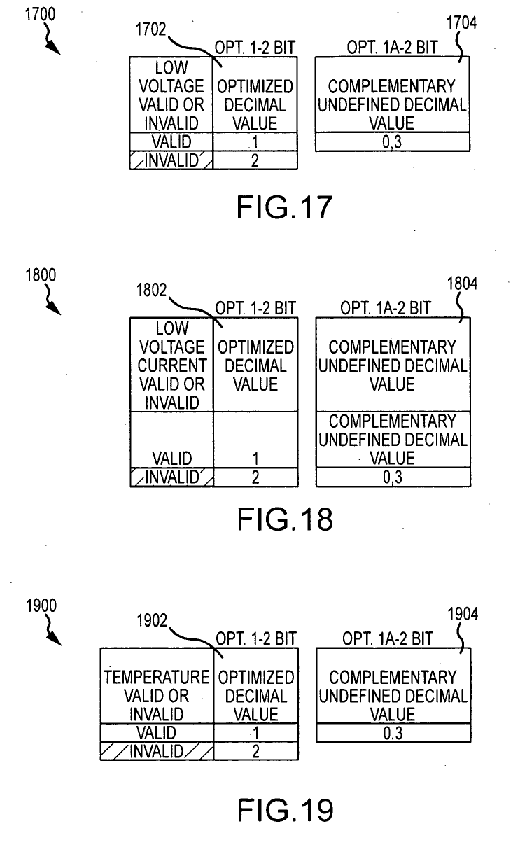

In one preferred embodiment, the low voltage response security enumeration is a two bit enumeration, such as that depicted in FIG. 17. Specifically, FIG. 17 provides a table 1700 of various low voltage response security enumeration values 1702 for the second encoded response message, dependent on whether the low voltage response is deemed to be valid or invalid, in accordance with an exemplary embodiment of the present invention.

For example, in the depicted embodiment, if the low voltage response is determined to be valid, then the low voltage response security enumeration for the second encoded response message is assigned a value equal to one, or 01 in binary form. Conversely, if the low voltage response is determined to be invalid, then the low voltage response security enumeration for the second encoded response message is assigned a value equal to two, or 10 in binary form. These values protect against certain memory fault errors that could result in one binary digit changing to another, while otherwise minimizing the number of binary digits required for this security enumeration. It will be appreciated that these low voltage response security enumeration values 1702, and/or the order thereof, may vary in different embodiments.

FIG. 17 also depicts a set of undefined values 1704 for the low voltage response security enumerations, for additional security. For example, if it is determined in the interpretation of the second encoded response message (such as in step 328 of the communications process 300 of FIG. 3) that a low voltage response security enumeration has a value that is equal to any of the undefined values 1704, this serves as an indication that an error has occurred, and appropriate remedial action can be taken. In the depicted embodiment, the undefined values 1704 include the following values: zero (00 in binary form) and three (11 in binary form). However, it will be appreciated that the undefined values 1704 may vary in other embodiments.

In addition, and returning again to FIG. 6, a low voltage current response security enumeration is generated (step 616). The low voltage current response security enumeration provides a measure of security as to whether the value for the low voltage current response generated in step 604 is valid. In a preferred embodiment, the low voltage current response security enumeration uses possible values that are at least two bit errors removed from one another in binary form. The low voltage current response security enumeration is also preferably generated using the second computer system 120 of the battery charger 108 of FIG. 1.

In one preferred embodiment, the low voltage current response security enumeration is a two bit enumeration, such as that depicted in FIG. 18. Specifically, FIG. 18 provides a table 1800 of various low voltage current response security enumeration values 1802 for the second encoded response message, dependent on whether the low voltage current response is deemed to be valid or invalid, in accordance with an exemplary embodiment of the present invention.

For example, in the depicted embodiment, if the low voltage current response is determined to be valid, then the low voltage current response security enumeration for the second encoded response message is assigned a value equal to one, or 01 in binary form. Conversely, if the low voltage current response is determined to be invalid, then the low voltage current response security enumeration for the second encoded response message is assigned a value equal to two, or 10 in binary form. These values protect against certain memory fault errors that could result in one binary digit changing to another, while otherwise minimizing the number of binary digits required for this security enumeration. It will be appreciated that these low voltage current response security enumeration values 1802, and/or the order thereof, may vary in different embodiments. For example, the low voltage current response security enumeration values 1802 may differ from the low voltage response security enumeration values used in the second encoded response message.

FIG. 18 also depicts a set of undefined values 1804 for the low voltage current response security enumerations, for additional security. For example, if it is determined in the interpretation of the second encoded response message (such as in step 328 of the communications process 300 of FIG. 3) that a low voltage current response security enumeration has a value that is equal to any of the undefined values 1804, this serves as an indication that an error has occurred, and appropriate remedial action can be taken. In the depicted embodiment, the undefined values 1804 include the following values: zero (00 in binary form) and three (11 in binary form). However, it will be appreciated that the undefined values 1804 may vary in other embodiments.

Also, and returning again to FIG. 6, a temperature security enumeration is generated (step 618). The temperature security enumeration provides a measure of security as to whether the charger temperature value obtained in step 606 is valid. In a preferred embodiment, the temperature security enumeration uses possible values that are at least two bit errors removed from one another in binary form. The temperature security enumeration is also preferably generated using the second computer system 120 of the battery charger 108 of FIG. 1.

In one preferred embodiment, the temperature security enumeration is a two bit enumeration, such as that depicted in FIG. 19. Specifically, FIG. 19 provides a table 1900 of various temperature security enumeration values 1902 for the second encoded response message, dependent on whether the charger temperature value is deemed to be valid or invalid, in accordance with an exemplary embodiment of the present invention.

For example, in the depicted embodiment, if the charger temperature value is determined to be valid, then the temperature security enumeration for the second encoded response message is assigned a value equal to one, or 01 in binary form. Conversely, if the charger temperature value is determined to be invalid, then the temperature security enumeration for the second encoded response message is assigned a value equal to two, or 10 in binary form. These values protect against certain memory fault errors that could result in one binary digit changing to another, while otherwise minimizing the number of binary digits required for this security enumeration. It will be appreciated that these temperature security enumeration values 1902, and/or the order thereof, may vary in different embodiments. For example, the temperature security enumeration values 1902 may differ from the low voltage response security enumeration values and/or the low voltage current response security enumerations used in the second encoded response message.

FIG. 19 also depicts a set of undefined values 1904 for the temperature security enumerations, for additional security. For example, if it is determined in the interpretation of the second encoded response message (such as in step 328 of the communications process 300 of FIG. 3) that a temperature security enumeration has a value that is equal to any of the undefined values 1904, this serves as an indication that an error has occurred, and appropriate remedial action can be taken. In the depicted embodiment, the undefined values 1904 include the following values: zero (00 in binary form) or three (11 in binary form). However, it will be appreciated that the undefined values 1904 may vary in other embodiments.

In addition, and returning back to FIG. 6, a checksum is calculated (step 620). In a preferred embodiment, the checksum is calculated so as to include each of the low voltage response, the low voltage current response, the charger temperature value, the active discharge response, the wake-up response, the identifier, the low voltage response security enumeration, the low voltage current response security enumeration, and the temperature security enumeration. However, this may vary in other embodiments.

Next, each of the low voltage response, the low voltage current response, the charger temperature value, the active discharge response, the wake-up response, the identifier, the low voltage response security enumeration, the low voltage current response security enumeration, the temperature security enumeration, and the checksum are combined together to complete the formation of the second encoded response message (step 622).

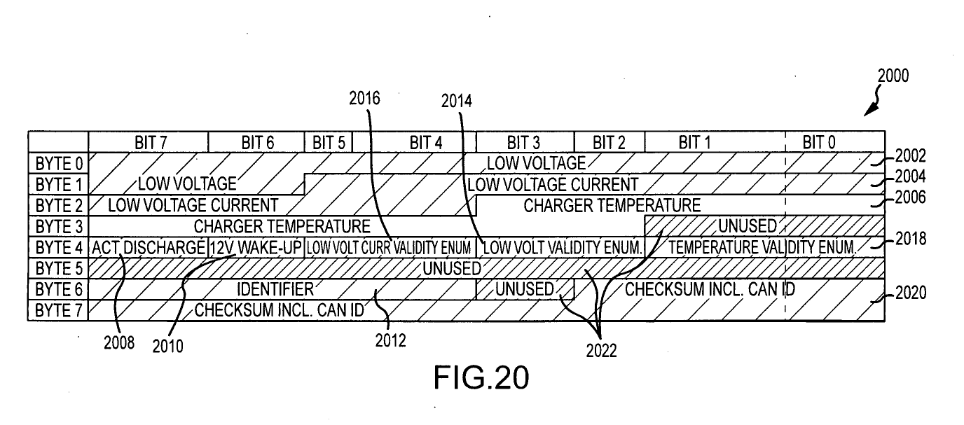

FIG. 20 depicts an exemplary second encoded response message 2000 that can be generated pursuant to the communications process 300 of FIG. 3 (and, specifically, pursuant to step 322, described in greater detail in connection with the process of FIG. 6), in accordance with an exemplary embodiment of the present invention. In the depicted embodiment, the second encoded response message 2000 includes a ten bit low voltage response 2002, a ten bit low voltage current response 2004, a ten bit charger temperature value 2006, a one bit active discharge response 2008, a one bit wake-up response 2010, a four bit identifier 2012, a two bit low voltage response security enumeration 2014, a two bit low voltage current response security enumeration 2016, a two bit temperature security enumeration 2018, and an eleven bit checksum 2020.

The second encoded response message 2000 thus includes security protections for the low voltage response, the low voltage current response, and the temperature value, in addition to providing the checksum that provides additional protections for each of the components of the second encoded response message 2000. The second encoded response message 2000 accomplishes this while still minimizing the amount of information and messages needed for the communications. For example, redundant messages are not required for security. As a result, throughput is also potentially reduced in the communications between the battery control unit 106 and the battery charger 108, thereby also potentially reducing traffic on the data connection 110 and/or potentially reducing software and/or other overhead.

In the depicted embodiment, the exemplary second encoded response message 2000 further includes eleven unused bits 2022, for example for use in the event that additional information, data, and/or security enumerations may be required. It will be appreciated that the encoded command message may differ from the exemplary encoded command message 2000 depicted in FIG. 20. It will similarly be appreciated that the steps depicted in FIG. 6 and/or described above may differ, and/or may be performed in a different order than that depicted and/or described.

Accordingly, an improved method has been provided for communicating between a battery control unit and a battery charger for a hybrid vehicle, for example with an improved information flow and/or improved security for values being transmitted therebetween. Also, an improved program product and system are provided for such improved communications between a battery control unit and a battery charger for a hybrid vehicle. These methods, programs, and systems allow for varying levels of security for the different message components (depending on their relative importance and/or other factors), while minimizing the amount of information and messages needed. As a result, redundant messages are not required, and throughput is potentially reduced in the communications between the battery control unit 106 and the battery charger 108, thereby also potentially reducing traffic on the data connection 110 and/or potentially reducing software and/or other overhead.

It will be appreciated that the processes, programs, and systems described herein may vary in certain embodiments. It will similarly be appreciated that various steps of the processes and programs described herein may be performed simultaneously and/or in a different order than that presented in the figures and/or described herein, and that the methods and programs described herein may also be utilized and/or implemented in connection with any number of other different types of devices, systems, processes, and/or programs.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for communicating between a battery charger and a battery control unit in a hybrid vehicle, the method comprising the steps of:
forming a first message with at least a renewable energy storage system (RESS) command and a command security measure for the RESS command;
transmitting the first message from the battery control unit to the battery charger;
forming a second message in response to the first message with at least an RESS response and a response security measure for the RESS response; and
transmitting the second message from the battery charger to the battery control unit.

2. The method of claim 1, further comprising the steps of:
forming the first message with an RESS voltage command, an RESS current command, a first command security measure for the RESS voltage command, and a second command security measure for the RESS current command; and
forming the second message with a first RESS response to the RESS voltage command, a second RESS response to the RESS current command, a third command security measure for the first RESS response, and a fourth command security measure for the second RESS response.

3. The method of claim 2, further comprising the steps of:
assigning one of a first plurality of values to the first command security measure based at least in part on whether the RESS voltage command is valid, wherein the first plurality of values, in binary form, are at least two bit errors removed from one another;
assigning one of a second plurality of values to the second command security measure based at least in part on whether the RESS current command is valid, wherein the second plurality of values, in binary form, are at least two bit errors removed from one another;
assigning one of a third plurality of values to the third command security measure based at least in part on whether the first RESS response is valid, wherein the third plurality of values, in binary form, are at least two bit errors removed from one another; and
assigning one of a fourth plurality of values to the fourth command security measure based at least in part on whether the second RESS response is valid, wherein the fourth plurality of values, in binary form, are at least two bit errors removed from one another.

4. The method of claim 3, further comprising the steps of:
forming the first message also with a low voltage command and a fifth command security measure for the low voltage command.

5. The method of claim 4, further comprising the steps of:
forming a third message in response to the first message with at least a third RESS response to the low voltage command and a sixth command security measure for the third RESS response; and
transmitting the third message from the battery charger to the battery control unit.

6. The method of claim 5, further comprising the steps of:
assigning one of a fifth plurality of values to the fifth command security measure based at least in part on whether the low voltage command is valid, wherein the fifth plurality of values, in binary form, are at least two bit errors removed from one another; and
assigning one of a sixth plurality of values to the sixth command security measure based at least in part on whether the third RESS response is valid, wherein the sixth plurality of values, in binary form, are at least two bit errors removed from one another.

7. The method of claim 6, further comprising the steps of:
generating an additional command for inclusion in the first message;
generating an additional response to the additional command for inclusion in the second message, the third message, or both;
obtaining a parameter indicator for inclusion in the second message, the third message, or both; and
calculating a checksum for each of the first message, the second message, and the third message.

8. A program product for at least facilitating communications between a battery charger and a battery control unit in a hybrid vehicle, the program product comprising:
(a) a program configured to at least facilitate:
forming a first message with at least a renewable energy storage system (RESS) command and a command security measure for the RESS command;
transmitting the first message from the battery control unit to the battery charger;
forming a second message in response to the first message with at least an RESS response and a response security measure for the RESS response; and
transmitting the second message from the battery charger to the battery control unit; and
(b) a computer-readable signal bearing media bearing the program.

9. The program product of claim 8, wherein:
the first message comprises:
an RESS voltage command;
an RESS current command;
a first command security measure for the RESS voltage command; and
a second command security measure for the RESS current command; and
the second message comprises:
a first RESS response to the RESS voltage command;
a second RESS response to the RESS current command;
a third command security measure for the first RESS response;
and a fourth command security measure for the second RESS response.

10. The program product of claim 9, wherein the program is further configured to at least facilitate:
assigning one of a first plurality of values to the first command security measure based at least in part on whether the RESS voltage command is valid, wherein the first plurality of values, in binary form, are at least two bit errors removed from one another;
assigning one of a second plurality of values to the second command security measure based at least in part on whether the RESS current command is valid, wherein the second plurality of values, in binary form, are at least two bit errors removed from one another;
assigning one of a third plurality of values to the third command security measure based at least in part on whether the first RESS response is valid, wherein the third plurality of values, in binary form, are at least two bit errors removed from one another; and
assigning one of a fourth plurality of values to the fourth command security measure based at least in part on whether the second RESS response is valid, wherein the fourth plurality of values, in binary form, are at least two bit errors removed from one another.

11. The program product of claim 10, wherein the first message further comprises:
a low voltage command; and
a fifth command security measure for the low voltage command.

12. The program product of claim 11, wherein the program is further configured to at least facilitate:
forming a third message in response to the first message with at least a third RESS response to the low voltage command and a sixth command security measure for the third RESS response; and
transmitting the third message from the battery charger to the battery control unit.

13. The program product of claim 12, wherein the program is further configured to at least facilitate:
assigning one of a fifth plurality of values to the fifth command security measure based at least in part on whether the low voltage command is valid, wherein the fifth plurality of values, in binary form, are at least two bit errors removed from one another; and
assigning one of a sixth plurality of values to the sixth command security measure based at least in part on whether the third RESS response is valid, wherein the sixth plurality of values, in binary form, are at least two bit errors removed from one another.

14. The program product of claim 13, wherein the program is further configured to at least facilitate:
generating an additional command for inclusion in the first message;
generating an additional response to the additional command for inclusion in the second message, the third message, or both;
obtaining a parameter indicator for inclusion in the second message, the third message, or both; and
calculating a checksum for each of the first message, the second message, and the third message.

15. A control system for a battery for a hybrid vehicle, the control system comprising:
a battery control unit configured to at least facilitate:
forming a first message with at least a renewable energy storage system (RESS) command and a command security measure for the RESS command;
transmitting the first message; and
receiving a second message with at least an RESS response and a response security measure for the RESS response; and
a battery charger coupled to the battery control unit and configured to at least facilitate:
receiving the first message from the battery control unit;
forming the second message in response to the first message; and
transmitting the second message to the battery control unit.

16. The control system of claim 15, wherein:
the first message comprises:
an RESS voltage command;
an RESS current command;
a first command security measure for the RESS voltage command; and
a second command security measure for the RESS current command; and
the second message comprises:
a first RESS response to the RESS voltage command;
a second RESS response to the RESS current command;
a third command security measure for the first RESS response;
and a fourth command security measure for the second RESS response.

17. The control system of claim 16, wherein:
the battery control unit is further configured to at least facilitate:
assigning one of a first plurality of values to the first command security measure based at least in part on whether the RESS voltage command is valid, wherein the first plurality of values, in binary form, are at least two bit errors removed from one another; and
assigning one of a second plurality of values to the second command security measure based at least in part on whether the RESS current command is valid, wherein the second plurality of values, in binary form, are at least two bit errors removed from one another; and
the battery charger is further configured to at least facilitate:
assigning one of a third plurality of values to the third command security measure based at least in part on whether the first RESS response is valid, wherein the third plurality of values, in binary form, are at least two bit errors removed from one another; and
assigning one of a fourth plurality of values to the fourth command security measure based at least in part on whether the second RESS response is valid, wherein the fourth plurality of values, in binary form, are at least two bit errors removed from one another.

18. The control system of claim 17, wherein the first message further comprises:
a low voltage command; and
a fifth command security measure for the low voltage command.

19. The control system of claim 18, wherein the battery control unit is further configured to at least facilitate transmitting a third message from the battery charger to the battery control unit, the third message comprising a third RESS response to the low voltage command and a sixth command security measure for the third RESS response.

20. The control system of claim 19, wherein:
the battery control unit is further configured to at least facilitate assigning one of a fifth plurality of values to the fifth command security measure based at least in part on whether the low voltage command is valid, wherein the fifth plurality of values, in binary form, are at least two bit errors removed from one another; and
the battery charger is further configured to at least facilitate assigning one of a sixth plurality of values to the sixth command security measure based at least in part on whether the third RESS response is valid, wherein the sixth plurality of values, in binary form, are at least two bit errors removed from one another.
